(19) United States
(12) Patent Application Publication
(10) Pub. No.: US 2006/0268668 A1
(43) Pub. Date: Nov. 30, 2006

(54) Tilt controller based on distortion-free control signals and an optical reproducing apparatus thereof

(75) Inventors: Myoung-wook Lee, Suwon-si (KR); Tatsuhiro Otsuka, Suwon-si (KR); Jae-seong Shim, Anyang-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/432,330

(22) Filed: May 12, 2006

(30) Foreign Application Priority Data
May 17, 2005 (KR) 2005-41120

(51) Int. Cl. G11B 7/00

(52) U.S. Cl. 369/44.11

(57) ABSTRACT

A tilt controller controlling a tilt of an actuator of an optical pickup based on distortion-free control signals and an optical reproducing apparatus including the tilt controller. A control signal generator generates firs and second control signals to control the actuator. A reference control signal generator generates a reference control signal using the first and second control signals. A driving signal generator generates driving signals for the actuator using the first and second control signals, and the reference control signal. Protection circuits prevent the reference control signal generator from affecting first and second control signals. Accordingly, distortion of the actuator driving signals is eliminated.

### CROSS-REFERENCE TO RELATED APPLICATIONS

This application claims the benefit of Korean Patent Application No. 2005-41120, filed May 17, 2005, in the Korean Intellectual Property Office, the disclosure of which is incorporated herein by reference.

### BACKGROUND OF THE INVENTION

1. Field of the Invention

Aspects of the present invention relate to a tilt controller and an optical reproducing apparatus incorporating the tilt controller. More specifically, aspects of the present invention relate to a tilt controller controlling a tilt based on distortion-free control signals, and an optical reproducing apparatus incorporating the tilt controller.

2. Description of the Related Art

FIG. 1 is a view explaining a conventional tilt controller. Referring to FIG. 1, a conventional tilt controller includes an actuator control signal generator 10, a first resistor R₁, a second resistor R₂, an actuator driving signal generator 20, and an actuator 30.

The actuator control signal generator 10 generates and outputs a first control signal V_{CS1} at a node N1 and a second control signal V_{CS2} at a node N2, the signals being used for controlling an operation of the actuator 30, using a focus control signal and a tilt control signal.

The first and second resistors R₁ and R₂ generate and output a reference control signal V_{CSR} through voltage division of the first and second control signals, V_{CS1} and V_{CS2} output from the actuator control signal generator 10. The reference control signal V_{CSR} is a median voltage of the first control signal V_{CS1} and the second control signal V_{CS2}.

The actuator driving signal generator 20 generates and outputs a first driving signal V_{DS1}, a second driving signal V_{DS2}, and a reference driving signal V_{DSR}, the driving signals being used for driving the actuator 30, using the first control signal V_{CS1}, second control signal V_{CS2}, and reference control signal V_{CSR}.

The actuator 30 is driven according to the first, second, and reference driving signals V_{DS1}, V_{DS2} and V_{DSR} output from the actuator driving signal generator 20, and adjusts a tilt of a pickup (not shown) that reads the data recorded on optical discs.

As shown in FIG. 1, in order to generate the reference control signal V_{CSR} through voltage division of the first control signal V_{CS1} and the second control signal V_{CS2}, node N₁ is electrically connected to node N₂ through the first resistor R₁ and the second resistor R₂; thus, the first control signal V_{CS1} and the second control signal V_{CS2} are mutually affected. This is further intensified when a difference between the first control signal V_{CS1} and the second control signal V_{CS2} is large.

Since the first control signal V_{CS1}and the second control signal V_{CS2} are mutually affected, the first control signal V_{CS1} and the second control signal V_{CS2} may be distorted. An example is that, although the voltage of the first control signal V_{CS1} and the voltage of the second control signal V_{CS2} should be “2.52V” and “1.59V” respectively, the voltage of the first control signal V_{CS1} and the voltage of the second control signal V_{CS2} are distorted to “2.36V” (<“2.52”) and “1.75V” (>“1.59”), respectively, due to the influence caused by the electrical connection betweens the nodes N₁ and N₂.

Where the first control signal V_{CS1} and the second control signal V_{CS2} are distorted, the driving signals V_{DS1}, V_{DS2} and V_{DSR} generated by the actuator driving signal generator 20 based on distorted signals V_{CS1} and V_{CS2} are also distorted. As a result, the tilt adjustment of the actuator 30 becomes inaccurate, so that the data recorded on optical discs cannot be read, or are inaccurately read.

### SUMMARY OF THE INVENTION

Aspects of the present invention solve the above and/or other problems. Particularly, an aspect of the invention is to provide a tilt controller and an optical reproducing apparatus thereof, in which the tilt controller performs tilt control based on distortion-free control signals for more accurate tilt control by preventing the control signals used for controlling the operation of the actuator from being distorted, the actuator adjusting the tilt of a pickup.

According to an aspect of the invention a tilt controller comprises a control signal generator generating a first control signal and a second control signal, the signals being used to control an operation of an actuator adjusting a tilt of a pickup that reads data recorded on an optical disc, a reference control signal generator generating a reference control signal using the first control signal and the second control signal, a driving signal generator generating signals used to drive the actuator using the first and second control signals generated by the control signal generator, and the reference control signal generated by the reference signal generator, a first control signal protector preventing the first control signal from being distorted by the reference control signal generator, and a second control signal protector preventing the second control signal from being distorted by the reference control signal generator.

The first control signal protector prevents the first control signal from being changed by the reference control signal generator, and the second control signal protector prevents the second control signal from being changed by the reference control signal generator.

The first control signal protector may include a first voltage follower having an input connected with the first control signal and an output connected with a first terminal of the reference control signal generator, and the second control signal protector may include a second voltage follower having an input connected with the second control signal and an output connected with a second terminal of the reference control signal generator.

An optical reproducing apparatus according to an aspect of the invention comprises a pickup reading data recorded on an optical disc, an actuator adjusting a tilt of the pickup, a control signal generator generating a first control signal and a second control signal, the signals being used to control an operation of an actuator adjusting a tilt of a pickup that reads the data recorded on the optical disc, a reference control signal generator generating a reference control signal using the first control signal and the second control signal, a driving signal generator generating signals used to drive the actuator using the first and second control signals generated by the control signal generator, and the reference control signal generated by the reference signal generator, a first control signal protector preventing the first control signal from being distorted by the reference control signal generator, and a second control signal protector preventing the second control signal from being distorted by the reference control signal generator.

The first control signal protector prevents the first control signal from being changed by the reference control signal generator, and the second control signal protector prevents the second control signal from being changed by the reference control signal generator.

The first control signal protector may include a first voltage follower having an input connected with the first control signal and an output connected with a first terminal of the reference control signal generator, and the second control signal protector may include a second voltage follower having an input connected with the second control signal and an output connected with a second terminal of t the reference control signal generator.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a view explaining a conventional tilt controller;

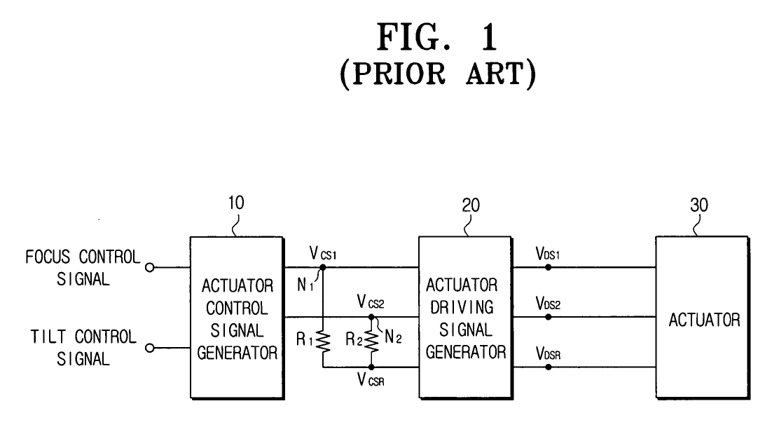

FIG. 2 is a block diagram of a tilt controller according to an embodiment of the invention; and

FIG. 3 is a detailed block diagram of the tilt controller shown in FIG. 2.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

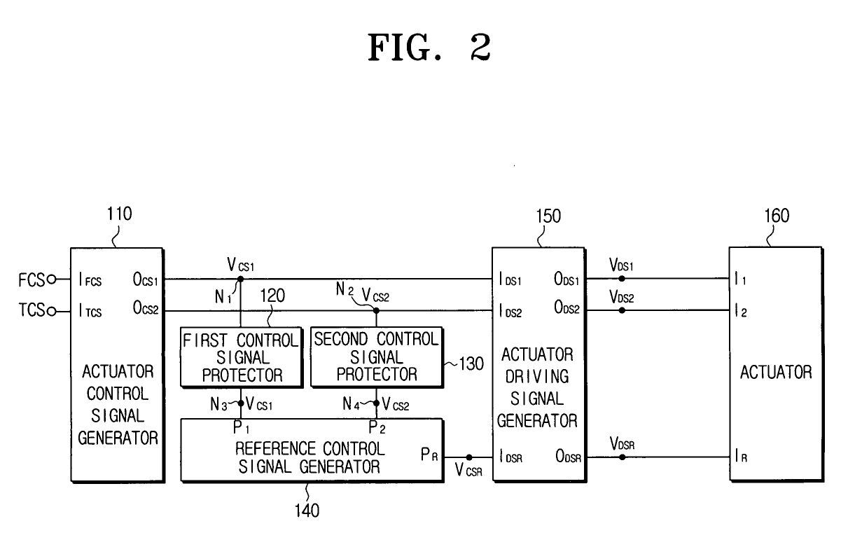

FIG. 2 is a block diagram of a tilt controller according to an embodiment of the invention. The tilt controller comprises an actuator control signal generator 110, a first control signal protector 120, a second control signal protector 130, a reference control signal generator 140, an actuator driving signal generator 150, and an actuator 160.

The actuator control signal generator 110 generates and outputs control signals, the signals being used to control an operation of the actuator 160, using a Focus Control Signal (FCS) received through a terminal I_{FCS} and a Tilt Control Signal (TCS) received through a terminal I_{TCS}.

The actuator control signal generator 110 generates a first control signal V_{CS1} output through a terminal O_{CS1} and a second control signal output through a terminal O_{CS2}.

The first control signal protector 120 is a protection circuit preventing the first control signal V_{CS1} from being distorted. Specifically, the first control signal protector 120 prevents a signal output from a terminal P₁ of the reference control signal generator 140 from flowing into a node N₁, thereby preventing a voltage of the first control signal V_{CS1} from being changed by the signal output at the terminal P₁.

The first control signal protector 120 enables a signal having a same voltage as a voltage of the first control signal V_{CS1} to be applied to the terminal P₁ of the reference control signal generator 140. That is, the first control signal protector 120 controls the voltage of the terminal P₁ of the reference control signal generator 140 (i.e., the voltage of a node N₃) to be the same as the voltage of the first control signal V_{CS1}.

The second control signal protector 130 is a protection circuit preventing the second control signal V_{CS2} from being distorted. Specifically, the second control signal protector 130 prevents a signal output from a terminal P₂ of the reference control signal generator 140 from flowing into a node N₂, thereby preventing a voltage of the second control signal V_{CS2} from being changed by the signal output at the terminal P₂.

The second control signal protector 130 enables a signal having a same voltage as a voltage of the second control signal V_{CS2} to be applied to the terminal P₂ of the reference control signal generator 140. That is, the second control signal protector 130 controls the voltage of the terminal P₂ of the reference control signal generator 140 (i.e., the voltage of a node N₄) to be the same as the voltage of the second control signal V_{CS2}.

The reference control signal generator 140 generates and outputs a reference control signal V_{CSR} using the signals V_{CS1} and V_{CS2} applied from the first control signal protector 120 and the second control signal protector 130. The reference control signal V_{CSR} generated by the reference control signal generator 140 is a median voltage of the voltage of the signal V_{CS1} applied from the first control signal protector 120 and the voltage of the signal V_{CS2} applied from the second control signal protector 130.

The actuator driving signal generator 150 generates and outputs driving signals to drive the actuator 160 using the first control signal V_{CS1} input through a terminal I_{DS1}, the second control signal V_{CS2} input through a terminal I_{DS2}, and the reference control signal V_{CSR} input through a terminal I_{DSR}.

The actuator driving signal generator 150 generates a first driving signal V_{DS1} output through a terminal O_{DS1}, a second driving signal V_{DS2} output through a terminal O_{DS2}, and a reference driving signal V_{DSR} output through a terminal O_{DSR}.

The actuator 160 is driven according to the first driving signal VDS1 input through a terminal I₁, the second driving signal VDS2 input through a terminal I₂, and the reference driving signal V_{DSR} input through a terminal I_{R}, and adjusts the tilt of a pickup (not shown) that reads the data recorded on an optical disc.

The driving signals V_{DS1}, V_{DS2} and V_{DSR} used for driving the actuator 160 are the signals generated by the actuator driving signal generator 150 using the control signals V_{CS1}, V_{CS2} and V_{CSR}. The first control signal V_{CS1} and the second control signal V_{CS2} are not distorted due to first and second control signal protectors 120, 130 preventing the first and second control signals V_{CS1} and V_{CS2}, respectively, from being distorted by t the reference control signal generator 140.

The first and second control signals V_{CS1} and V_{CS2} are not distorted, and the driving signals V_{DS1}, V_{DS2} and V_{DS3} generated using the first and second control signals V_{DS1} and V_{DS2} are not distorted. Accordingly, the tilt of a pickup is more accurately adjusted by the actuator 160 that is driven by the distortion-free driving signals.

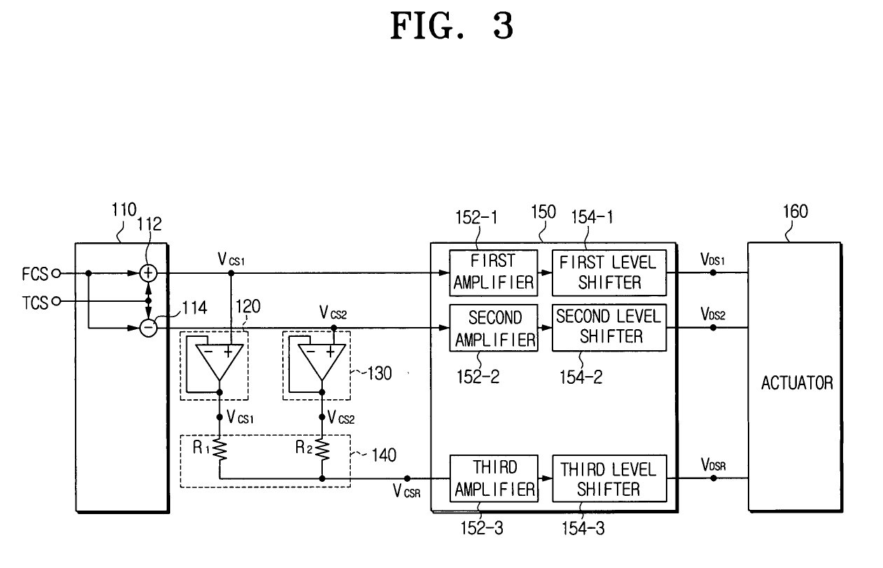

Hereafter, the tilt controller shown in FIG. 2 is explained in more detail with reference to FIG. 3. FIG. 3 is a detailed block diagram of the tilt controller shown in FIG. 2.

As shown in FIG. 3, the actuator control signal generator 110 includes an adder 112 and a subtracter 114. The adder 112 outputs an added signal (FCS+TCS) of the FCS and the TCS as the first control signal V_{CS1}. The subtracter 114 outputs a subtracted signal (FCS−TCS) of the FCS and the TCS as the second control signal V_{CS2}.

The first control signal protector 120 includes a first voltage follower 120 that is provided between an input terminal of a first amplifier 152-1 and an end point of a first resistor R₁ provided in the reference control signal generator 140.

The second control signal protector 130 includes a second voltage follower 130 that is provided between an input terminal of a second amplifier 152-2 and an end point of a second resistor R₂ provided in the reference control signal generator 140.

The output voltages of the voltage followers 120 and 130 are the same as the voltages of the first and second control signals V_{CS1}, V_{CS2}, respectively. The voltage followers 120 and 130 prevent the first and second control signals V_{CS1} and V_{CS2} from being distorted, i.e., the first and second control signals V_{CS1} and V_{CS2} from being changed due to a mutual interaction of the first and second control signals V_{CS1} and V_{CS2} within the reference control signal generator 140.

The reference control signal generator 140 includes a first resistor R₁ and a second resistor R₂, and generates the reference control signal V_{CSR} through voltage division. Where the first resistor R₁ and the second resistor R₂ have a same resistance, the voltage of the reference control signal V_{CSR} becomes a median voltage of the first and second control signals V_{CS1} and V_{CS2}.

The actuator driving signal generator 150 is implemented in the first and second amplifiers 152-1 and 152-2 and a third amplifier 152-3 amplifying the first, second, and reference control signals V_{CS1}, V_{CS2} and V_{CSR}, respectively, and first, second, and third level shifters 154-1, 154-2, 154-3 generating the first, second, and reference driving signals V_{DS1}, V_{DS2} and V_{DS3}, respectively, by shifting voltage levels of the signals amplified by the first, second and third amplifiers, 152-1, 152-2 and 152-3, respectively.

As explained above, a tilt controller provides more accurate tilt control of a pickup actuator by preventing control signals used for controlling the operation of the actuator from being distorted. Such a tilt controller may be applied to an optical reproducing apparatus that reads data recorded on an optical discs using a pickup.

As described above, according to aspects of the invention, distortions of control signals are prevented by protecting the control signals used for controlling the operation of an actuator that adjusts the tilt of a pickup. Accordingly, a tilt is controlled based on distortion-free control signals, thereby enhancing reproducing performance of the data recorded on the optical disc.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. A tilt controller comprising:
a control signal generator generating a first control signal and a second control signal to control an actuator adjusting a tilt of a pickup that reads data recorded on an optical disc;
a reference control signal generator generating a reference control signal using the first control signal and the second control signal;
a driving signal generator generating signals to drive the actuator using the first and second control signals and the reference control signal;
a first control signal protector preventing the first control signal from being distorted by the reference control signal generator; and
a second control signal protector preventing the second control signal from being distorted by the reference control signal generator.

2. The controller as claimed in claim 1, wherein:
the first control signal protector prevents a voltage of the first control signal from being changed by a first signal output from a first terminal of the reference control signal generator, and
the second control signal protector prevents a voltage of the second control signal from being changed by a second signal output from a second terminal of the reference control signal generator.

3. The controller as claimed in claim 2, wherein:
the first control signal protector comprises a first voltage follower having an input connected to the first control signal and an output connected to the first terminal of the reference control signal generator, and
the second control signal protector comprises a second voltage follower having an input connected to the second control signal and an output connected to the second terminal of reference control signal generator.

4. An optical reproducing apparatus comprising:
a pickup reading data recorded on an optical disc;
an actuator adjusting a tilt of the pickup;
a control signal generator generating a first control signal and a second control signal to control the actuator adjusting the tilt of the pickup;
a reference control signal generator generating a reference control signal using the first control signal and the second control signal;
a driving signal generator generating signals to drive the actuator using the first and second control signals and the reference control signal;
a first control signal protector preventing the first control signal from being distorted by the reference control signal generator; and
a second control signal protector preventing the second control signal from being distorted by the reference control signal generator.

5. The apparatus as claimed in claim 4, wherein:
the first control signal protector prevents a voltage of the first control signal from being changed by a first signal output from a first terminal of the reference control signal generator, and
the second control signal protector prevents a voltage of the second control signal from being changed by a second signal output from a second terminal of the reference control signal generator.

6. The apparatus as claimed in claim 5, wherein:
the first control signal protector comprises a first voltage follower having an input connected to the first control signal and an output connected to the first terminal of the reference control signal generator, and
the second control signal protector comprises a second voltage follower having an input connected to the second control signal and an output connected to the second terminal of reference control signal generator.

7. An optical reproducing apparatus comprising:
a pickup reading data recorded on an optical disc;
an actuator adjusting a tilt of the pickup;
a control signal generator adding a focus control signal and a tilt control signal to generate a first control signal and subtracting the focus control signal and the tilt control signal to generate a second control signal;
first and second voltage followers buffering the first and second control signals, respectively;
a voltage divider generating a reference control signal based on voltage division of the first and second buffered control signals; and
a driving signal generator, comprising:
first, second and third amplifiers amplifying the first, second and reference control signals, respectively, and
first, second and third level shifters which shift a level of the amplified first, second and reference control signals, respectively, to drive the actuator.

8. A control circuit for preventing distortion in signals used to drive an actuator of an optical pickup, the circuit comprising:
a control signal generator generating first and second control signals based on a focus control signal and a tilt control signal;
first and second voltage followers buffering the first and second control signals, respectively;
a reference control signal generator generating a reference control signal to drive the actuator using the first and second buffered control signals; and
an actuator driving signal generator driving the actuator based on the non-buffered first and second control signals and the reference control signal.
